(19) United States
(12) Patent Application Publication
(10) Pub. No.: US 2006/0285301 A1
(43) Pub. Date: Dec. 21, 2006

(54) Method for making a pre-laminated inlet

(75) Inventors: Stephane Provost, Sandillon (FR); Aurelie Janot, Orleans (FR)

Correspondence Address: OSHA LIANG L.L.P., 1221 MCKINNEY STREET, SUITE 2800, HOUSTON, TX, 77010, US

(73) Assignee: AXALTO SA, Montrouge Cedex (FR)

(21) Appl. No.: 10/555,457

(22) PCT Filed: May 4, 2004
(86) PCT No.: PCT/IB04/01575

§ 371 Date: Dec. 14, 2005

(30) Foreign Application Priority Data
May 5, 2003 (EP) 032910812
Jun. 17, 2003 (EP) 032914715

(51) Int. Cl. G06K 19/077

(52) U.S. Cl. 361/737; 156/293

(57) ABSTRACT

A method comprising the steps of depositing an RF component (11) onto the top surface of a first sheet-like substrate (10), depositing an antenna (12, 13) connected to the RF component (11) onto the top surface of the first substrate (10), depositing a second substrate (14) onto the top surface of the first substrate (10) to cover at least the RF component (11) and the antenna (12, 13), and laminating the resulting assembly to give a unitary assembly having a substantially uniform thickness.

### BACKGROUND OF THE INVENTION

1. Field of the Invention

This invention concerns a method to manufacture a prelaminated inlet, an inlet obtained by this method and a card including such an inlet.

2. Related Art

The manufacture of contactless smart cards involves the use of a radiofrequency (RF) microelectronic component connected to an antenna.

This RF assembly is fastened to a substrate, generally made of plastic. The assembly consisting of the RF component, the antenna and the substrate is called an inlet by the smart card industry.

This inlet is then laminated between several plastic layers to provide the thickness and rigidity required by the contactless card. The outer layers are printed with designs which are then protected by a thin layer of transparent plastic called an “overlay”.

The inlets either consist of a flexible substrate supporting the RF component and the antenna or a relatively thick substrate in which the RF component and the antenna are inserted. In the second case, the inlet is realised by lamination in several layers, hence the name of prelaminated inlet.

When manufacturing prelaminated inlets, electronic components previously encapsulated in an interconnection circuit known as a module are generally used. The module is then connected to the antenna which has previously been engraved on the substrate.

In another method of manufacture, the RF component is soldered directly on the substrate and the antenna according to the flip-chip technology. Although it reduces the number of manufacturing steps, this technology has the disadvantage of being more fragile since the component is not protected by the interconnection circuit.

In the method currently used to manufacture prelaminated inlets, the antenna is first deposited and bonded on the substrate, engraved on it, or inserted using an ultrasound method.

The component is now placed on the substrate and soldered to the antenna, then a plastic sheet is laminated on top to protect the assembly and produce an inlet of constant thickness.

The current method has numerous disadvantages. It is expensive and difficult, since numerous plastic sheets are required, often of different thicknesses and qualities.

In addition, cavities must be machined out on the various layers in order to insert the component, these cavities then having to be filled with a resin to remove the residual gaps between the component and the plastic layer.

### SUMMARY OF THE INVENTION

The invention is a new method to manufacture prelaminated inlets which is easy to implement and therefore inexpensive.

The invention concerns a method to manufacture a prelaminated inlet, including the following steps:
placing an RF component on the top surface of a first support forming a sheet,
connecting an antenna to the RF component is deposited on the top surface of the first support,
placing a second support on the top surface of the first support, covering at least the RF component and the antenna,
laminating the assembly to form a monobloc of approximately uniform thickness.

According to other characteristics of the invention:
before placing the RF component, a cavity of size greater than or equal to the size of this RF component is machined for it in the top surface of the first support;
some resin is deposited in the cavity before placing the RF component, to fill the gaps left in the cavity after lamination;
a cavity of size greater than or equal to the size of the RF component is machined in the second support before the component is placed;
some resin is deposited on the top of the RF component before placing the second support, in order to fill the gaps left in the cavity after lamination;
the first and second supports are made from plastic of softening point less than 90° C.;
the plastic of the first and second supports is selected from the following group:
   PVC
   PETg
   PVC/ABS,
   ABS.
the assembly consisting of the first and second supports of the RF component and the antenna is laminated between two plastic sheets of melting point greater than 150° C.;
one of the supports is made from plastic of melting point less than 90° C. and the other support is made from plastic of melting point greater than 150° C.;
a third sheet made from plastic of softening point greater than 150° C. is laminated with the assembly of the first two supports, so that the support made from plastic of softening point less than 90° C. lies between the two sheets consisting of a plastic of softening point greater than 150° C.;
the plastic of softening point greater than 150° C. is PC or PET type;
the RF component consists of an active silicon component encapsulated in an interconnection circuit;
the RF component consists of an active silicon component assembled directly on a substrate using the flip-chip method.

The invention also concerns a contactless integrated circuit card including an inlet and the corresponding inlet manufactured according to the method of the invention.

### BRIEF DESCRIPTION OF THE DRAWINGS

It will be easier to understand the invention on reading the description below, given as an example and referring to the attached drawings, on which:

FIG. 1 is a cross-section of a single layer inlet whose RF component is assembled using the flip-chip method according to the prior art,

FIG. 2 is a cross-section of a single-layer inlet whose RF component is encapsulated in a module according to the prior art,

FIGS. 3A, 3B, 3C and 3D are cross-sections illustrating the successive steps of a first mode of realisation of the invention,

FIGS. 4A, 4B, 4C, 4D, 4E and 4F are cross-sections illustrating the successive steps of a second mode of realisation of the invention,

FIGS. 5A, 5B, 5C and 5D are cross-sections illustrating the successive steps of a third mode of realisation of the invention.

### DETAILED DESCRIPTION OF PREFERRED EMBODIMENTS

In the figures, identical reference numbers refer to identical or similar parts.

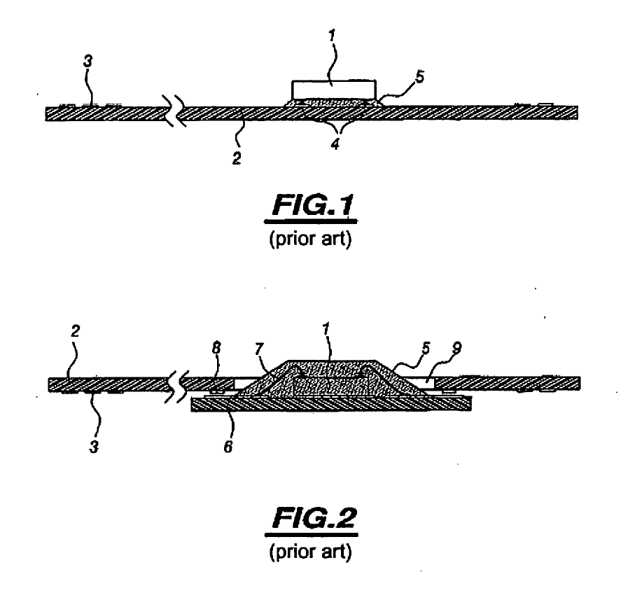

When manufacturing an inlet with a component assembled using the flip-chip method according to the prior art, FIG. 1, component 1 is soldered on a plastic support 2 on which an antenna 3 with at least two contact studs 4 has previously been deposited. Soldering is carried out to ensure electrical continuity between the studs 4 of the antenna and the contact areas of component 1. An electrically insulating resin 5 is deposited between component 1 and support 2 to provide the mechanical strength of the assembly.

When component 1 is assembled in a module, FIG. 2, it is first deposited on a support called a lead-frame which has electrical contact areas 6, wires 7 are then soldered between these contact areas 6 and the contact studs of component 1. A resin 5 is deposited over the assembly to protect component 1 and its electrical connections 7. When manufacturing the inlet, the module is soldered on support 2 on which an antenna 3 has previously been deposited, said antenna having at least two contact studs 8 designed to electrically connect antenna 3 to the module via contact areas 6. FIG. 2 illustrates a mode of realisation in which the module contacts are on the same side as the component. Consequently, a cavity 9 must be machined in support 2 so that areas 6 and 8 can be placed in contact.

In a well known mode of realisation of the prior art, not represented on a figure, the module has its contact areas on the side of the lead-frame opposite that on which the component is bonded. The module can therefore be soldered on the inlet support without first making a cavity. However, the thickness of the inlet obtained is equal to the sum of the thicknesses of the module and support 2, which is greater than that of the inlet obtained in the mode of realisation shown on FIG. 2.

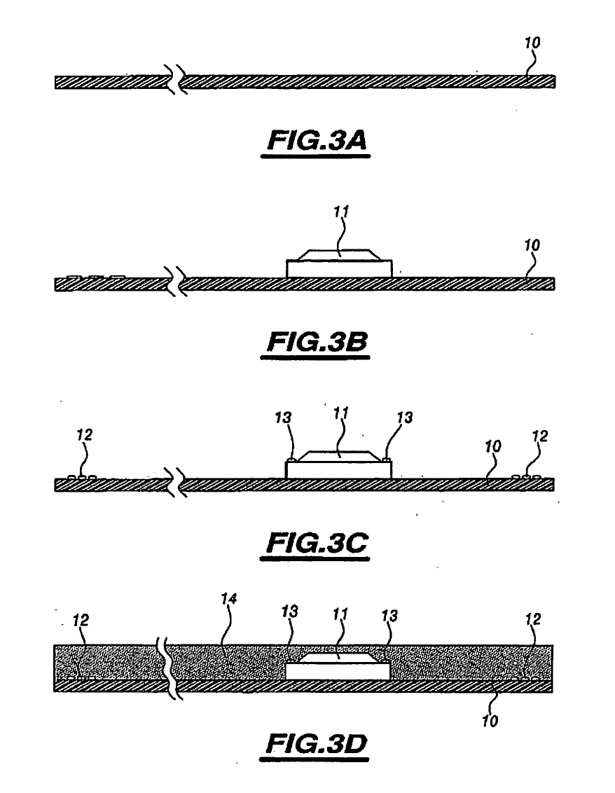

According to a preferred mode of realisation of the invention, illustrated by FIGS. 3A, 3B, 3C and 3D, a first plastic sheet 10, FIG. 3A, is prepared to take an RF component 11 as module, FIG. 3B. Component 11 then being positioned on support 10, antenna 12 with its contact studs 13 is deposited in a traditional manner on the assembly, FIG. 3C. In the preferred mode of realisation, the antenna is engraved on support 10, but it can also be wound then bonded onto the support or inserted using a traditional ultrasound technique.

At this step in the realisation, the RF component is electrically connected to the antenna via contact studs 13.

A second plastic layer 14 is deposited over the assembly which is then laminated to obtain a monobloc assembly of constant thickness, as illustrated on FIG. 3D.

It should be pointed out that carefully choosing the plastic for layer 14 avoids the need to first machine a cavity to accommodate component 11. The plastic chosen should therefore be soft enough to deform and take the shape of component 11 during lamination. Plastics of softening point, or VICAT point, less than 90° C. are ideal for this type of use and amongst these plastics good results have been obtained with polyvinyl chloride (PVC), polyethylene terephthalate glycol (PETg) and plastics based on acrylonitrile-butadiene-styrene (ABS), or PVC/ABS mixtures.

This choice can also be extended to the first support 10, in order to distribute the stresses and deformations during lamination over both supports.

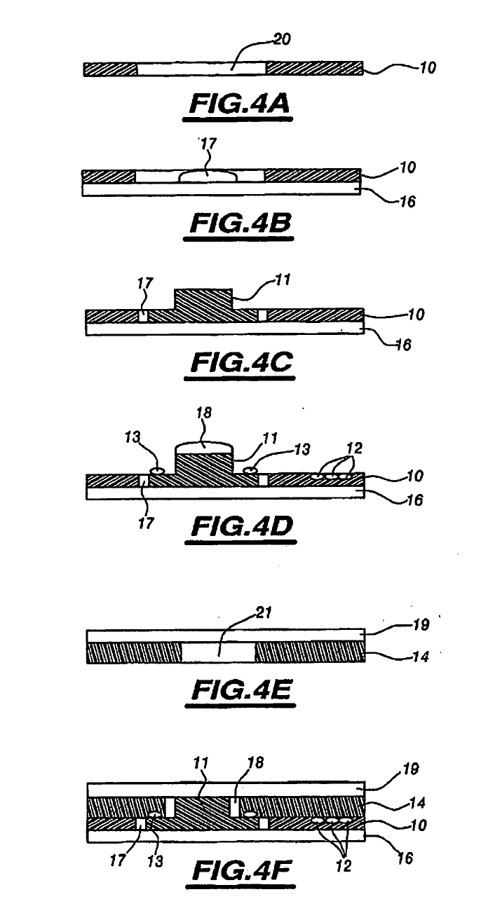

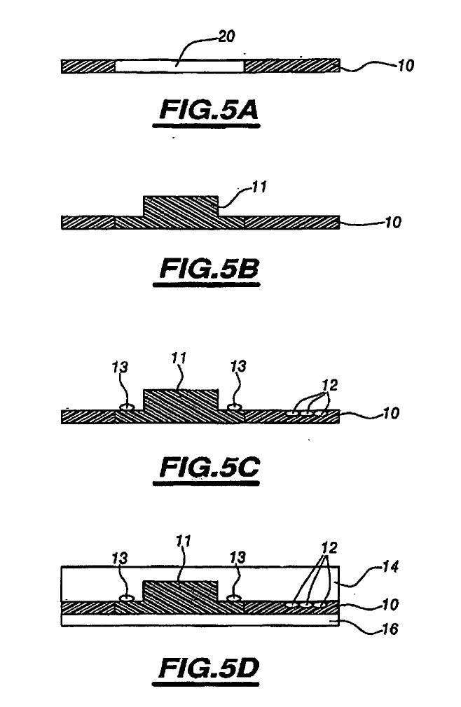

Some applications, however, may have high mechanical requirements, especially regarding the bending strength. In this case, the monobloc obtained previously must be strengthened by laminating one or more layers of a stronger plastic to it. A first option consists in adding, FIG. 4F, a sheet 16 and 19 of strong plastic on each side. In a second option, FIG. 5D, a single layer 16 of strong plastic is added.

Plastics of softening points greater than 150° C. such as polycarbonate (PC) or polyethylene terephthalate (PET) provide the necessary mechanical strength, increasing the strength to 15 000 bending cycles instead of the 1 000 bending cycles generally encountered with a traditional prelaminated assembly.

A second mode of realisation of the invention is illustrated on FIGS. 4A, 4B, 4C, 4D, 4E and 4F.

A cavity 20 is machined in a first support 10, FIG. 4A. This cavity 20 is large enough to insert a module 11.

A second support 16 is positioned under the first support and a drop of resin 17 is deposited in the cavity formed by the first and second supports. As an alternative, the cavity machined in support 10 can be a blind hole, the drop of resin then being deposited at the bottom of this hole.

After depositing the resin 17, module 11 is positioned in the cavity, FIG. 4C. The drop of resin 17 therefore holds module 11 in position and fills the gaps left in the cavity by module 11.

Antenna 12, 13 is then deposited on support 10 and connected to module 11 by studs 13 as in the first mode of realisation, FIG. 4D.

A second drop of resin 18 is deposited on the top of module 11.

In addition, two plastic layers 14 and 19, FIG. 4E, are pre-bonded together and a second cavity 21, of size greater than or equal to the size of module 11, is machined in layer 14. Preferably, the thickness of layer 14 is equal to or slightly greater than the height of the part of module 11 which protrudes from the cavity of support 10.

This assembly is then deposited, FIG. 4F, on the first support 10 and the resulting structure laminated. The drop of resin 18 then fills the gaps of the second cavity 21 left by the top part of module 11.

Concerning the cavities machined in the first layer 10 and in the top layer 14, the type of plastic used is unimportant. Preferably, however, plastics of softening point less than 90° C. are used.

In a third mode of realisation illustrated by FIGS. 5A, 5B, 5C and 5D, a cavity 20 is machined in the first support 10, as in the second mode of realisation, FIG. 5A.

Module 11 is then positioned inside the cavity. Preferably, the first support 10 is approximately the same thickness as the lead-frame of module 11, FIG. 5B.

As previously, antenna 12 is then deposited, FIG. 5C, and connected to module 11.

The assembly is then laminated between an upper layer 14 of relatively soft plastic and a lower layer 16 of relatively hard plastic which provides the mechanical strength of the assembly, FIG. 5D.

Obviously these various modes of realisation can be combined to form other modes of realisation.

For example, the third mode of realisation can be combined with machining of a cavity in the upper layer in order to use a relatively hard plastic for this upper layer.

Prelaminated inlets can therefore be realised using a method which, having a limited number of steps, is inexpensive to implement.

1. Method to manufacture a prelaminated inlet including the following steps:
placing an RF component on the top surface of a first support forming a sheet,
connecting an antenna to the RF component is deposited on the top surface of the first support,
placing a second support on the top surface of the first support, covering at least the RF component and the antenna,
laminating the assembly to form a monobloc assembly of approximately uniform thickness.

2. Method to manufacture a prelaminated inlet according to claim 1, wherein, before placing the RF component, a cavity of size greater than or equal to the size of this RF component is made for it in the top surface of the first support.

3. Method to manufacture a prelaminated inlet according to claim 2, wherein some resin is deposited in the cavity before placing the RF component, in order to fill the gaps left in the cavity after lamination.

4. Method to manufacture a prelaminated inlet according to claim 1, wherein a cavity of size greater than or equal to the size of the RF component is made in the second support before the component is placed.

5. Method to manufacture a prelaminated inlet according to claim 4, wherein some resin is deposited on the top of the RF component before placing the second support, in order to fill the gaps left in the cavity after lamination.

6. Method to manufacture a prelaminated inlet according to claim 1, wherein the first and second supports are made from plastic of softening point less than 90° C.

7. Method to manufacture a prelaminated inlet according to claim 6, wherein the plastic of the first and second supports is selected from the following group:
PVC
PETg
PVC/ABS,
ABS.

8. Method to manufacture a prelaminated inlet according to claim 6 wherein the assembly of the first and second supports of the RF component and the antenna is laminated between two plastic sheets of melting point greater than 150° C.

9. Method to manufacture a prelaminated inlet according to claim 1, wherein one of the supports is made from plastic of melting point less than 90° C. and the other support is made from plastic of melting point greater than 150° C.

10. Method to manufacture a prelaminated inlet according to claim 9, wherein a third sheet made from a plastic of softening point greater than 150° C. is laminated with the assembly of the first two supports, so that the support made from plastic of softening point less than 90° C. is inserted between the two sheets made from plastic of softening point greater than 150° C.

11. Method to manufacture a prelaminated inlet according to claim 8, wherein the plastic of softening point greater than 150° C. is PC or PET type.

12. Method to manufacture a prelaminated inlet according to claim 1, wherein the RF component consists of an active silicon component encapsulated in an interconnection circuit.

13. Method to manufacture a prelaminated inlet according to claim 1, wherein the RF component consists of an active silicon component assembled directly on a substrate using the flip-chip method.

14. Prelaminated inlet manufactured according to the method of claim 1.

15. Contactless integrated circuit card including an inlet according to claim 14.
